(19) United States
(12) Patent Application Publication
(10) Pub. No.: US 2014/0208015 A1
(43) Pub. Date: Jul. 24, 2014

(54) MEMORY CONTROL SYSTEM AND POWER CONTROL METHOD

(71) Applicant: Panasonic Corporation, Osaka (JP)

(72) Inventors: Takashi MUROYAMA, Nara (JP); Akira TAKAHASHI, Osaka (JP)

(73) Assignee: Panasonic Corporation, Osaka (JP)

(21) Appl. No.: 14/222,767

(22) Filed: Mar. 24, 2014

Related U.S. Application Data
(63) Continuation of application No. PCT/JP2012/005630, filed on Sep. 5, 2012.

(30) Foreign Application Priority Data
Sep. 28, 2011 (JP) 2011-213442

(51) Int. Cl. G06F 3/06

(52) U.S. Cl. CPC G06F 3/0653; G06F 3/061; G06F 3/0673
USPC 711/105

(57) ABSTRACT

A memory control system includes: a plurality of I/O circuits; and a power control circuit that performs, when a predetermined condition for usage states of memories is satisfied, and an unused memory is present among the memories, a power consumption reduction process for causing a target I/O circuit to consume less power than an other one of the I/O circuits, the target I/O circuit being an I/O circuit among the I/O circuits that is connected to the unused memory.

### CROSS REFERENCE TO RELATED APPLICATIONS

This is a continuation application of PCT International Application No. PCT/JP2012/005630 filed on Sep. 5, 2012, designating the United States of America, which is based on and claims priority of Japanese Patent Application No. 2011-213442 filed to on Sep. 28, 2011. The entire disclosures of the above-identified applications, including the specifications, drawings and claims are incorporated herein by reference in their entirety.

### FIELD

The present disclosure relates to a memory control system that controls power when memories are used, and a power control method.

### BACKGROUND

In recent years, along with the increased size and speed of a system LSI, the usage frequency and clock frequency of a dynamic random access memory (DRAM) are increasing. For this reason, not only the power consumption of the DRAM itself but also the power consumption of a peripheral circuit including a control circuit for the DRAM are increasing.

Patent Literature (PTL) 1 discloses a technique for reducing power consumption of a device using a DRAM by stopping supply of a power source (power) to the DRAM based on a usage state of the DRAM (hereinafter referred to as conventional technique A).

### CITATION LIST

### Patent Literature

### [PTL 1]

Japanese Unexamined Patent Application Publication No. 2005-025364

### SUMMARY

### Technical Problem

However, the conventional technique A stops the supply of the power source (power) to a memory (DRAM). As a result, to make the memory to which the power supply is stopped operational again, a time is required to supply the power, perform an initialization process on the memory, and so on. Thus, it takes some time to make the memory to which the power supply is stopped and which is inaccessible operational again.

One non-limiting and exemplary embodiment provides, for instance, a memory control system, that decreases a time until an inaccessible memory is made operational, and reduces power consumption.

### Solution to Problem

In order to achieve the above object, a memory control system according to an aspect of the present disclosure is a memory control system connected to a plurality of memories, the memory control system including: a plurality of I/O circuits; and a monitoring circuit that monitors usage states of the memories, wherein each of the I/O circuits is connected to one of the memories, when one of the memories is accessed, each of the I/O circuits that is connected thereto is used, the I/O circuit consumes power to operate, and the monitoring circuit determines, among the memories, a memory to which access is permitted, based on the usage states of the memories, the memory control system further including a power control circuit that performs, when a predetermined condition for the usage states of the memories is satisfied, and an unused memory is present among the memories, a power consumption reduction process for causing a target I/O circuit to consume less power than an other one of the I/O circuits, the target I/O circuit being an I/O circuit among the I/O circuits that is connected to the unused memory.

In other words, the memory control system includes a power control circuit that performs, when a predetermined condition for usage states of memories is satisfied, and an unused memory is present among the memories, a power consumption reduction process for causing a target I/O circuit to consume less power than an other one of the I/O circuits, the target I/O circuit being an I/O circuit among the I/O circuits that is connected to the unused memory.

Specifically, the target I/O circuit, the I/O circuit connected to the unused memory, is caused to consume less power than the other one of the I/O circuits. With this, it is possible to reduce the power consumption of the memory control system.

Moreover, to make the unused memory operational, it is only necessary to supply power to the target I/O circuit to cause the target I/O circuit to consume substantially as much power as the other one of the I/O circuits. For this reason, it is possible to decrease as much as possible a time until the unused memory that is inaccessible is made operational. Thus, it is possible to decrease as much as possible a time until an inaccessible memory is made operational, and to reduce power consumption.

Moreover, each of the I/O circuits may include a circuit used when the one of the memories connected to the I/O circuit is accessed, and the power control circuit may perform the power consumption reduction process for causing the target I/O circuit to disable the circuit included in the I/O circuit that is the target I/O circuit.

Moreover, the memories may be set to have an n number of segments, n being an integer greater than or equal to 2, each of the n number of the segments may correspond to all or part of a plurality of regions identified by the same address for the memories, and the memories may be accessed on a segment basis. The memory control system may further include a memory management circuit that (a) makes, every time an instruction to perform an access process for accessing one of the n number of the segments is received, the segment to be accessed valid and (b) makes, every time a predetermined process for causing the access process at least once is completed, the segment to be accessed invalid, wherein the monitoring circuit may determine, among the memories, the memory to which access is permitted, based on the number of valid segments among the n number of the segments.

Moreover, the predetermined condition may be a condition that a value dependent on the number of latest valid segments is less than or equal to a predetermined first threshold value.

Moreover, the value dependent on the number of the latest valid segments may be a ratio of the number of the latest valid segments to n.

Moreover, the first threshold value may be less than 0.5.

Moreover, each of the memories may be assigned a different priority level, each of the n number of the segments may be tit associated with segment information including memory usage information for identifying, among the memories, the memory to which access is permitted, and the monitoring circuit may determine, among the memories, the memory to which access is permitted, by updating, every time a process for accessing one of the n number of the segments is performed, the memory usage information included in the segment information so that access to, among the memories, a memory having a higher priority level as a memory corresponding to the segment to be accessed is permitted as the number of the valid segments is less.

Moreover, the memory control system may further include a plurality of functional circuits, wherein each of the functional circuits may perform a different process, and the monitoring circuit may determines among the memories, the memory to which access is permitted, based on a maximum memory capacity used in the process performed by each functional circuit.

Moreover, each of the I/O circuits may be a circuit that uses a differential signal.

A power control method according to another aspect of the present disclosure is a power control method performed by a memory control system connected to a plurality of memories, wherein the memory control system includes: a plurality of I/O circuits; and a monitoring circuit that monitors usage states of the memories, each of the I/O circuits is connected to one of the memories, when one of the memories is accessed, each of the I/O circuits that is connected thereto is used, the I/O circuit consumes power to operate, and the monitoring circuit determines, among the memories, a memory to which access is permitted, based on the usage states of the memories, the power control method comprising performing, when a predetermined condition for the usage states of the memories is satisfied, and an unused memory is present among the memories, a power consumption reduction process for causing a target I/O circuit to consume less power than an other one of the I/O circuits, the target I/O circuit being an I/O circuit among the I/O circuits that is connected to the unused memory.

### Advantageous Effects

The present disclosure makes it possible to decrease as much as possible a time until an inaccessible memory is made operational, and to reduce power consumption.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram illustrating a configuration of a processing device according to Embodiment 1 of the present disclosure.

FIG. 2 is a diagram schematically illustrating a configuration of a storage unit according to Embodiment 1 of the present disclosure.

FIG. 3 is a diagram illustrating a structure of an address conversion table according to Embodiment 1 of the present disclosure.

FIG. 4 is a diagram for illustrating segment information according to Embodiment 1 of the present disclosure.

FIG. 5 is a block diagram illustrating an exemplary configuration of an I/O circuit according to Embodiment 1 of the present disclosure.

FIG. 6 is a block diagram illustrating a configuration of a memory control system according to Embodiment 1 of the present disclosure.

FIG. 7 is a flow chart for memory usage setting processing according to Embodiment 1 of the present disclosure.

FIG. 8 is a flow chart for power consumption control processing according to Embodiment 1 of the present disclosure.

FIG. 9 is a graph for illustrating exemplary operations performed by the memory control system having a two-memory configuration according to Embodiment 1 of the present disclosure.

FIG. 10 is a flow chart for illustrating exemplary operations performed by the memory control system having a two-memory configuration according to Embodiment 1 of the present disclosure.

FIG. 11 is a flow chart for memory usage setting processing A according to Embodiment 1 of the present disclosure.

FIG. 12 is a graph for illustrating exemplary operations performed by the memory control system having a three-memory configuration according to Embodiment 1 of the present disclosure.

FIG. 13 is a flow chart for illustrating exemplary operations performed by the memory control system having a three-memory configuration according to Embodiment 1 of the present disclosure.

FIG. 14 is a block diagram illustrating a configuration of a processing device according to Embodiment 2 of the present disclosure.

FIG. 15 is a graph for illustrating exemplary operations performed by the memory control system having a two-memory configuration according to Embodiment 2 of the present disclosure.

### DESCRIPTION OF EMBODIMENTS

Hereinafter; embodiments of the present disclosure are described with reference to the Drawings. In the following description, the same structural elements are assigned the same reference signs. The structural elements also have the same names and functions. Thus, their detailed description may be omitted.

Each of the exemplary embodiments described below shows a general or specific example. The numerical values, shapes, materials, structural elements, the arrangement and connection of the structural elements, steps, the processing order of the steps etc. shown in the is following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

### Embodiment 1

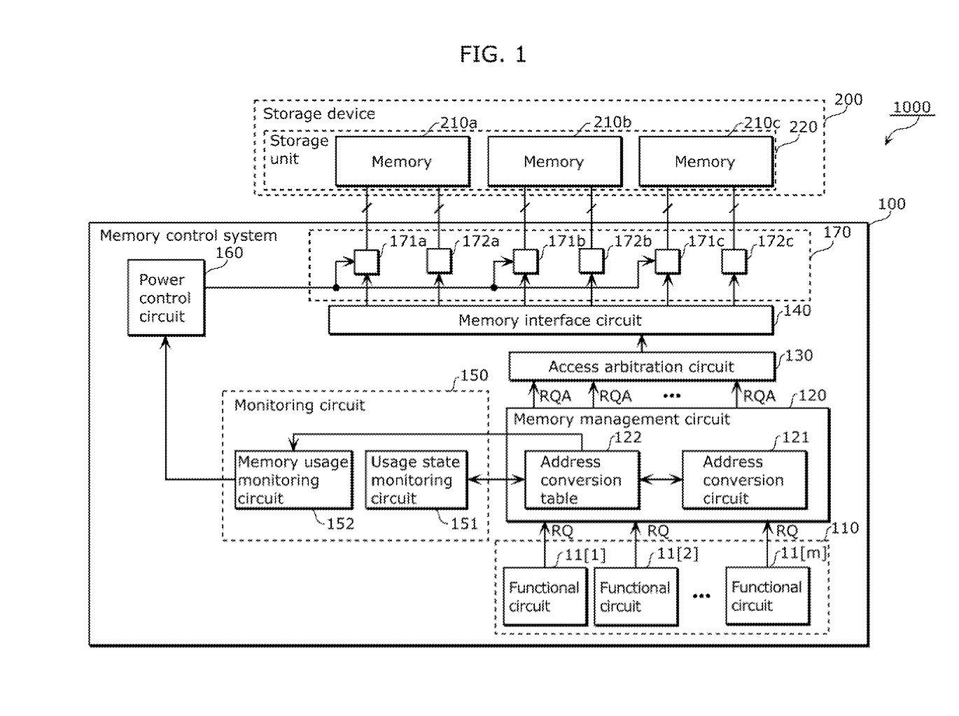

FIG. 1 is a block diagram illustrating a configuration of a processing device 1000 according to Embodiment 1.

The processing device 1000 processes data. The processing device 1000 is an imaging device, for instance. The imaging device is a digital video camera, a digital still camera, or the like, for example.

It is to be noted that the processing device 1000 is not limited to the imaging device, but may be another device (e.g., an image processing device) as long as the other device processes data.

The processing device 1000 includes a memory control system 100 and a storage device 200.

The storage device 200 includes memories 210a, 210b, and 210c. Each of the memories 210a, 210b, and 210c has the same number of addresses. It is to be noted that each of the memories 210a, 210b, and 210c may have a different number of addresses.

Hereinafter, the memories 210a, 210b, and 210c are also simply denoted as memories 210. A power source that is not shown always supplies power which each of the memories 210 included in the storage device 200 consumes to operate, to each memory 210. In other words, the power source that is not shown always supplies power which the memory 210 included in the storage device 200 consumes to hold data, to the memory 210.

The memory 210 is, as an example, a double-data-rate synchronous dynamic random access memory (DDR SDRAM). It is to be noted that the memory 210 is not limited to the DDR SDRAM, but may be another memory as long as the other memory operates using a differential signal (a differential I/O circuit).

It is also to be noted that the memory 210 may be still another memory (e.g., a DRAM) using no differential signal. Moreover, the number of the memories 210 included in the storage device 200 is not is limited to three, but may be two or at least four.

A storage unit 220 includes all of storage regions of the memory 210a, all of storage regions of the memory 210b, and all of storage regions of the memory 210c.

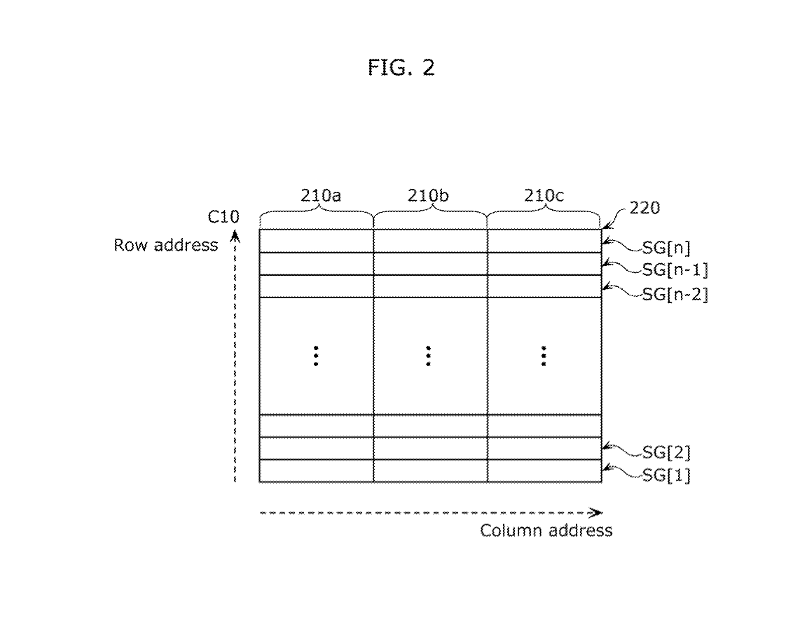

FIG. 2 is a diagram schematically illustrating a configuration of the storage unit 220.

The storage unit 220 includes the same number of segments as the number of segment information items included in an address conversion table 122 to be described later. In this embodiment, the number of the segment information items included in the address conversion table 122 is n (an integer greater than or equal to 2).

In this case, the storage unit 220 includes segments SG[1], SG[2], . . . , SG[n]. Hereinafter, each of the segments SG[1], SG[n] is also simply referred to as a segment SG or a segment.

Each of the memories 210a, 210b, and 210c includes an n number of storage regions C10 arranged in a column direction in FIG. 2. Each of an n number of the segments SG corresponds to a different one of the n number of the storage regions C10. Each of the n number of the storage regions C10 is identified by a row address.

In this embodiment, the storage regions C10 included in the respective memories 210a, 210b, and 210c have the same capacity. It is to be noted that the storage regions C10 included in the respective memories 210a, 210b, and 210c may have different capacities.

In this embodiment, a segment SG is set to all or part of regions identified by the same address for the memories 210a, 210b, and 210c included in the storage device 200. Here, the same address is a row address. The regions identified by the same address are, for instance, storage regions C10 of the memories 210a, 210b, and 210c that are in the same row in FIG. 2.

In this embodiment, the memories 210a, 210b, and 210c are set to have the n number of the segments SG. Each of the n number of the segments SG includes all or part of regions identified by the same address for the memories 210a, 210b, and 210c. In other words, each of the n number of the segments SG corresponds to all or part of the regions identified by the same address for the memories 210a, 210b, and 210c.

The memories 210a, 210b, and 210c are assigned priority levels for usage (hereinafter also referred to as usage priority levels). To put it another way, each of the memories is assigned a different priority level.

In this embodiment, as an example, usage priority levels are assigned so that the usage priority levels decrease in an order of the memory 210a, the memory 210b, and the memory 210c. Stated differently, among the memories 210a, 210b and 210c, the memory 210a has the highest priority level.

It is to be noted that a segment SG may include all or part of regions identified by different addresses in memories.

In FIG. 2, a row address identifies one of the segments SG. A column address identifies one of the memories 210a, 210b, and 210c.

The address conversion table 122 included in a memory management circuit 120 to be described later manages the segments SG.

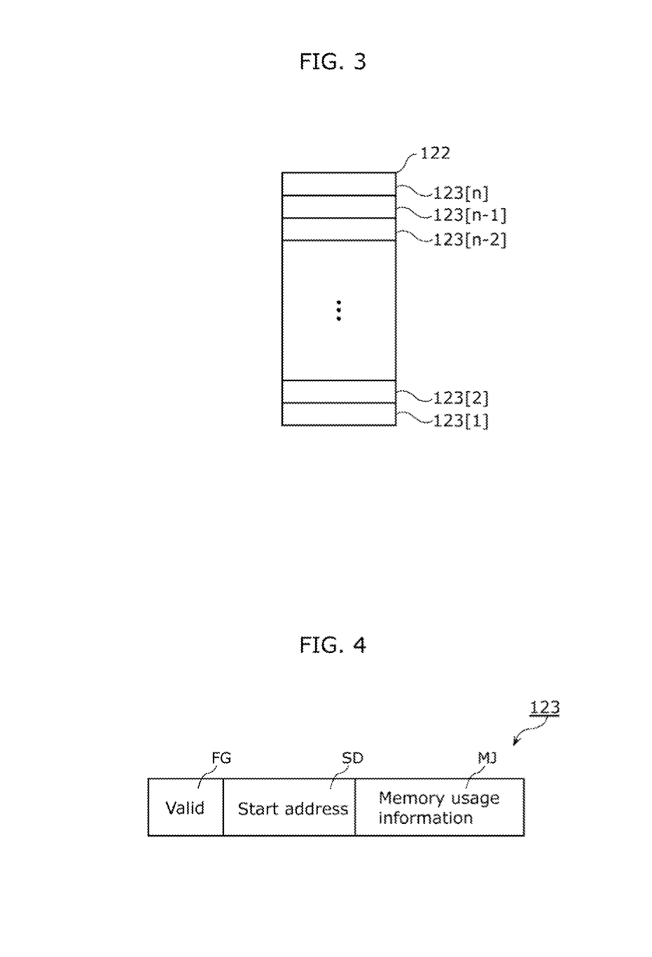

FIG. 3 is a diagram illustrating a structure of the address conversion table 122.

The address conversion table 122 includes segment information items 123[1], 123[2], . . . , 123[n]. Each of the segment information items 123[1], 123[2], . . . , 123[n] is associated with one of the segments SG[1], SG[2], . . . , SG[n]. For example, the segment information 123[1] is associated with the segment SG[1].

Hereinafter, each of the segment information items 123[1], 123[2], . . . , 123[n] is also simply referred to as segment information 123 or segment information. In other words, each of the segments SG is associated with the segment information 123.

FIG. 4 is a diagram for illustrating the segment information 123. As illustrated in FIG. 4, the segment information 123 includes validity determination information FG, a start address SD, and memory usage information MJ.

The validity determination information FG indicates whether or not the segment information 123 including the validity determination information FG is valid. The validity determination information FG indicates “valid” or “invalid.” When the validity determination information FG indicates “valid,” a segment corresponding to the segment information including the validity determination information FG is valid. When the validity determination information FG indicates “invalid,” the segment corresponding to the segment information including the validity determination information FG is invalid.

It is to be noted that in the initial state, validity determination information FG included in each of the n number of the segment information items 123 included in the address conversion table 122 indicates “invalid.”

Hereinafter, segment information 123 including validity determination information FG indicating “valid” is also referred to as valid segment information. A segment corresponding to valid segment information is a segment that is valid. Hereinafter, the segment that is valid is also referred to as a valid segment. The valid segment is a segment to which access is permitted.

Moreover, hereinafter, segment information 123 including validity determination information FG indicating “invalid” is also referred to as invalid segment information. A segment corresponding to invalid segment information is a segment that is invalid. Hereinafter, the segment that is invalid is also referred to as an invalid segment. The invalid segment is a segment to which access is inhibited.

The start address SD is a start address of the segment corresponding to the segment information 123 including the start address SD.

Though described in detail later, the memory usage information MJ is identification information for identifying, among memories, a memory to which access is permitted. The memory usage to information MJ indicates, as an example, the number of memories to be used. When the storage unit 220 includes storage regions of three memories, the memory usage information MJ indicates one of “1” to “3.” It is to be noted that in the initial state, the memory usage information MJ included in each of the n number of the segment information items 123 indicates “1.”

A size (capacity) of a segment SG changes with a value indicated by the memory usage information MJ.

For instance, when memory usage information MJ indicates “1,” a size of a segment SG corresponding to segment information 123 including the memory usage information MJ is equivalent to a capacity of one storage region C10. The storage region C10 is a storage region C10 in the memory 210a having the highest priority level. When the memory usage information MJ indicates “1,” in a process for accessing the segment corresponding to the memory usage information MJ, only the memory 210a is accessed, but the memory 210b is not accessed.

For instance, when the memory usage information MJ indicates “2,” the size of the segment SG corresponding to the segment information 123 including the memory usage information MJ is equivalent to a total capacity of two storage regions C10. The two storage regions C10 are a storage region C10 in the memory 210a and a storage region C10 in the memory 210b, respectively.

When the memory usage information MJ indicates “2,” in the process for accessing the segment corresponding to the memory usage information MJ, only the memories 210a and 210b are accessed, but the memory 210c is not accessed. In other words, the memory 210c having the lowest priority level is not accessed.

For instance, when the memory usage information MJ indicates “3,” the size of the segment SG corresponding to the segment information 123 including the memory usage information MJ is equivalent to a total capacity of three storage regions C10. The three storage regions C10 are a storage region C10 in the memory 210a, a storage region C10 in the memory 210b, and a storage region C10 in the memory 210c, respectively.

Back to reference to FIG. 1 again, the memory control system 100 includes a function unit 110, a memory management circuit 120, an access arbitration circuit 130, a memory interface circuit 140, a monitoring circuit 150, a power control circuit 160, and an I/O unit 170.

The function unit 110 includes functional circuits 11[1], 11[2], . . . , 11[m (an integer greater than or equal to 2)].

Each of the functional circuits 11[1], 11[2], . . . , 11[m] performs different processing. The functional circuit 11[1] performs processing A. The processing A is processing for coding image data, for example. The functional circuit 11[2] performs processing B. The processing B is processing for removing noise from an image, for instance.

A segment SG to be accessed in the storage unit 220 is previously assigned to each of the functional circuits 11[1], 11[2], . . . , 11[m].

Hereinafter, the segment to be accessed is also referred to as a target segment. The target segments assigned to the respective functional circuits 11[1], 11[2], . . . , 11[m] are different from each other. The target segment assigned to the functional circuit 11[1] is the segment SG[1], for example.

Hereinafter, each of the functional circuits 11[1], 11[2], . . . , 11[m] is also simply referred to as a functional circuit 11. In short, the memory control system 100 includes the functional circuits 11.

It is to be noted that the number of target segments assigned to at least one of an m number of the functional circuits 11 may be plural.

Each functional circuit 11 transmits an access request RQ to the memory management circuit 120 when a target segment needs to be accessed during execution of processing corresponding to the functional circuit 11. The access request RQ includes a logical address for identifying a target segment.

Moreover, the access request RQ includes a data storage instruction, a data readout instruction, and so on. The data storage instruction is an instruction to store data. The data readout instruction is an instruction to read out data. It is to be noted that when the access request RQ includes the data storage instruction, data to be stored is also added to the access request RQ.

It is to be noted that each functional circuit 11 transmits, when the processing corresponding to the functional circuit 11 is completed, a processing completion signal indicating that the processing is completed, to the memory management circuit 120.

The memory management circuit 120 includes an address conversion circuit 121 and the aforementioned address conversion table 122.

Every time an access request RQ is received, the address conversion circuit 121 performs an address conversion process.

In the address conversion process, the address conversion circuit 121 obtains a physical address by adding a start address of a target segment corresponding to the received access request RQ to the logical address included in the received access request. RQ. Here, the start address of the target segment is a start address SD included in segment information 123 included in the address conversion table 122 and corresponding to the target segment.

Moreover, every time an access request RQ is received, the address conversion circuit 121 performs validity setting processing. The access request RQ is an instruction to perform an access process to be described later.

In the validity setting processing, the address conversion circuit 121 identifies the segment information 123 corresponding to the target segment corresponding to the access request RQ. Then, when the identified segment information 123 is invalid segment information, the address conversion circuit 121 changes the segment information 123 to valid segment information. To put it another way, the address conversion circuit 121 changes the validity determination information FG of the identified segment information 123 so that the validity determination information FG indicates “valid.”

In short, in the validity setting processing, the address conversion circuit 121 (memory management circuit 120) makes a segment to be accessed (target segment) valid.

It is to be noted that every time a processing completion signal is received, the address conversion circuit 121 performs invalidity setting processing. The invalidity setting processing is processing for making a segment to be accessed invalid.

When the functional circuit 11 completes the processing corresponding to the functional circuit 11, the address conversion circuit 121 receives a processing completion signal from the functional circuit 11. The processing corresponding to the functional circuit 11 generates at least one access request RQ. The access process to be described later is performed according to the access request RQ.

In other words, every time predetermined processing for causing the access process at least once is completed, the address conversion circuit 121 (memory management circuit 120) performs the invalidity setting processing. The predetermined processing is the processing A performed by the functional circuit 11, for instance. The segment to be accessed is a target segment.

Specifically, in the invalidity setting processing, the address conversion circuit 121 (memory management circuit 120) identifies the functional circuit 11 that has transmitted the processing completion signal. Then, the address conversion circuit 121 changes, to the invalid segment information, the segment information 123 corresponding to the access request RQ already received from the identified functional circuit 11. To put it another way, the address conversion circuit 121 changes the validity determination information FG of the segment information 123 corresponding to the access request RQ so that the validity determination information FG indicates “invalid.”

Moreover, the address conversion circuit 121 performs segment size setting processing. In the segment size setting processing, the address conversion circuit 121 sets a size of a target segment according to a value indicated by memory usage information MJ included in segment information 123 included in the address conversion table 122 and corresponding to the target segment. Hereinafter, the size of the target segment set by the address conversion circuit 121 is also referred to as a set segment size.

For instance, when memory usage information MJ indicates “2,” a set segment size corresponding to segment information 123 including the memory usage information MJ is equivalent to a capacity of two storage regions C10.

Next, the address conversion circuit 121 generates an access request RQA by substituting the physical address included in the access request RQ for the obtained physical address. The access request RQA includes a set segment size.

Then, the address conversion circuit 121 transmits the access request RQA to the access arbitration circuit 130. It is to be noted that when receiving access requests RQ, the address conversion circuit 121 transmits access requests RQA to the access arbitration circuit 130.

The access arbitration circuit 130 arbitrates the received access requests RQA. Specifically, the access arbitration circuit 130 sorts the received access requests RQA in given order of priority level and transmits the access requests RQA in decreasing order of priority level, to the memory interface circuit 140.

Every time the memory interface circuit 140 receives the access request RQA, the memory interface circuit 140 performs the access process. The access process is a process for accessing one of the n number of the segments.

In the access process, the memory interface circuit 140 generates a command (waveform) for accessing the storage unit 220 or the like according to the received access request RQA. The command is a command (waveform) dependent on a type of memory 210 included in the storage device 200.

Next, as will hereinafter be described in detail, the memory interface circuit 140 accesses the storage unit 220 through the I/O unit 170 according to the generated command.

The following describes a configuration of the I/O unit 170.

The I/O unit 170 includes I/O circuits 171a, 171b, 171c, 172a, 172b, and 172c.

The I/O circuits 171a and 172a are connected to the memory 210a. The I/O circuits 171a and 172a are used when the memory 210a is accessed. The I/O circuits 171b and 172b are connected to the memory 210b. The I/O circuits 171b and 172b are used when the memory 210b is accessed.

The I/O circuits 171c and 172c are connected to the memory 210c. The I/O circuits 171c and 172c are used when the memory 210c is accessed.

Stated differently, the I/O circuits 171a, 171b, and 171c are connected to the memories 210a, 210b, and 210c, respectively. In short, the memory control system 100 is connected to the memories.

Each of the I/O circuits 171a, 171b, and 171c is a differential I/O circuit that uses a differential signal. The differential I/O circuit consumes more power to operate than a common I/O circuit that processes a single-ended signal. Moreover, a large amount of current flows through the differential I/O circuit even when the differential I/O circuit is in a standby state, and thus the differential I/O circuit consumes more power to operate.

It is to be noted that each of the I/O circuits 171a, 171b, and 171c is not limited to the differential I/O circuit, but may be a CMOS I/O circuit, for example.

Each of the I/O circuits 171a, 171b, and 171c is connected to the destination memory by a control line for transmitting a latch signal. It is to be noted that each of the I/O circuits 171a, 171b, and 171c may be connected to the destination memory by a control line for transmitting not only a latch signal but also a command or the like.

Each of the I/O circuits 172a, 172b, and 172c is connected to the destination memory by a data line for transmitting data and an address line. The I/O circuits 172a, 172b, and 172c are used when processing for allowing the destination memories to hold data (hereinafter also referred to as data holding processing) is performed. The data holding processing is refresh processing performed by a destination memory, for instance.

It is to be noted that the memory interface circuit 140 is further connected to each of the memories 210a, 210b, and 210c by a control line for transmitting a command or the like that is not shown.

Hereinafter, each of the I/O circuits 171a, 171b, and 171c is also simply referred to as an I/O circuit 171. Each I/O circuit 171 is used when a memory connected to the I/O circuit 171 is accessed. Moreover, the I/O circuit 171 consumes less power to operate than the memory 210.

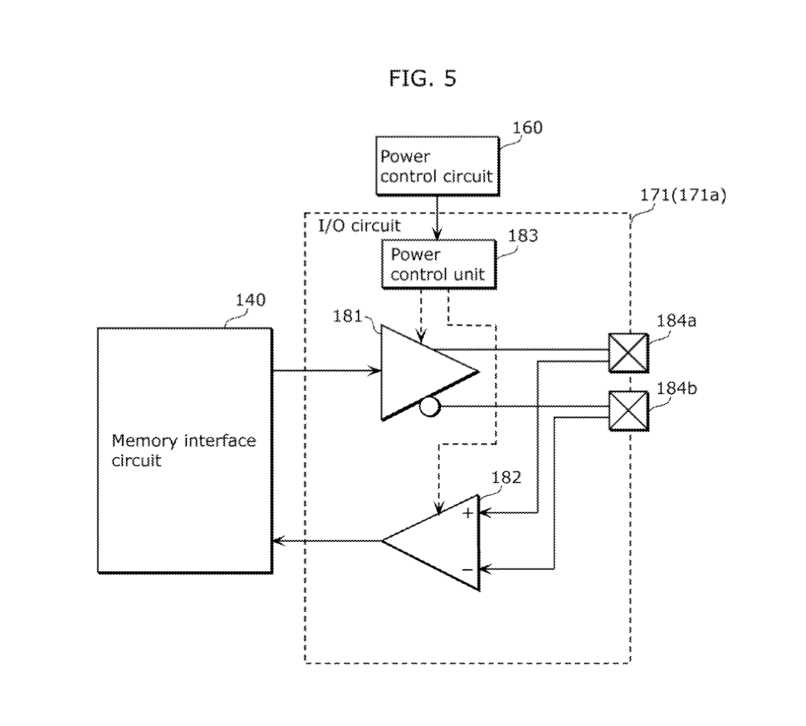

FIG. 5 is a block diagram illustrating an exemplary configuration of the I/O circuit 171. It is to be noted that for convenience of description, FIG. 5 illustrates the power control circuit 160 and the memory interface circuit 140 that are not included in the I/O circuit 171. The I/O circuit 171 in FIG. 5 is the I/O circuit 171a in one instance.

As illustrated in FIG. 5, the I/O circuit 171 includes a differential output amplifier 181, a differential amplifier 182, a power control unit 183, and terminals 184a and 184b.

The terminals 184a and 184b are connected to the memory 210 (e.g., memory 210a) connected to the I/O circuit 171.

The power control unit 183 goes into the ON state or the OFF state according to an instruction from the power control circuit 160. The power control unit 183 in the ON state electrically connects an external power source that is not shown, the differential output amplifier 181, and the differential amplifier 182. With this, the external power source supplies power to the differential output amplifier 181 and the differential amplifier 182.

The power control unit 183 in the OFF state electrically disconnects the external power source, the differential output amplifier 181, and the differential amplifier 182. In short, the power control unit 183 serves as a switch. With this, the power supply to the differential output amplifier 181 and the differential amplifier 182 is stopped.

It is to be noted that each of the differential output amplifier 181 and the differential amplifier 182 may have a power down function. The power down function is a function to stop operation.

In this case, the power control unit 183 powers down each of the differential output amplifier 181 and the differential amplifier 182 according to an instruction from the power control circuit 160.

Each of the differential output amplifier 181 and the differential amplifier 182 is a circuit used when the memory connected to the I/O circuit 171 is accessed.

The differential output amplifier 181 receives a single-ended signal (e.g., latch signal) and converts the single-ended signal into a differential signal. Then, the differential output amplifier 181 transmits the differential signal through the terminals 184a and 184b to the memory 210 connected to the I/O circuit 171.

When receiving a differential signal (e.g., latch signal) through the terminals 184a and 184b from the memory 210 (e.g., memory 210a), the differential amplifier 182 converts the differential signal into a single-ended signal.

It is to be noted that each of the I/O circuits 171b and 171c has the same configuration as the I/O circuit 171 in FIG. 5.

It is to be noted that each of the I/O circuits 172a, 172b, and 172c has a common configuration that makes it possible to transmit and receive a single-ended signal (data).

The following describes a specific example of processing performed by the memory interface circuit 140. The memory interface circuit 140 accesses, on a segment basis, the storage unit 220 including all of the storage regions of the memories 210. That is to say, the memory interface circuit 140 accesses the memories 210 on a segment basis. In other words, the memories 210 are accessed on a segment basis.

When an access request RQA includes a data storage instruction, the memory interface circuit 140 performs data storage processing for storing data added to the access request RQA into the storage unit 220. In the data storing processing, a segment in the storage unit 220 into which the data is stored is a target segment having a set segment size.

For example, the set segment size is equivalent to a total capacity of two storage regions C10. In this case, the memory interface circuit 140 transmits the data to be stored to the I/O circuits 172a and 172b, and latch signals to the I/O circuits 171a and 171b. Then, the memory interface circuit 140 further transmits write commands to the memories 210a and 210b through control lines not shown. With this, the data is stored into the target segment in the memories 210a and 210b.

On the other hand, when the access request RQA includes a data readout instruction, the memory interface circuit 140 performs data readout processing. In the data readout processing, the memory interface circuit 140 transmits read commands to the memories 210a and 210b through the control lines not shown. Then, the memory interface circuit 140 receives a latch signal through the I/O circuit 171a from the memory 210a, and a latch signal through the I/O circuit 171b from the memory 210b. Moreover, the memory interface circuit 140 receives data to be read through the I/O circuits 172a and 172b from the memories 210a and 210b.

In the data readout processing, a segment in the storage unit 220 from which the data is read is a target segment having a set segment size.

Next, the monitoring circuit 150 is described.

As will hereinafter be described in detail, the monitoring circuit 150 monitors usage states of the memories. The monitoring circuit 150 includes a usage state monitoring circuit 151 and a memory usage monitoring circuit 152.

The usage state monitoring circuit 151 performs usage state monitoring processing for monitoring the usage states of the memories 210 included in the storage device 200. In other words, the usage state monitoring circuit 151 continually monitors usage states of the segments included in the storage unit 220 (storage device 200). Hereinafter, a usage rate of the segments included in the storage unit 220 (storage device 200) is also referred to as a segment usage rate.

In the usage state monitoring processing, the usage state monitoring circuit 151 calculates the number of valid segment information items by reference to the validity determination information FG of each of the n number of the segment information items 123 included in the address conversion table 122. The number of the valid segment information items is the number of valid segments.

Then, the usage state monitoring circuit 151 calculates a segment usage rate using an equation of (the number of the valid segments)/n. For instance, when n is 64 and the number of the valid segments is 32, the segment usage rate is 50%.

As stated above, the usage state monitoring circuit 151 calculates the segment usage rate.

The memory usage monitoring circuit 152 performs memory usage monitoring processing.

In the memory usage monitoring processing, the memory usage monitoring, circuit 152 determines whether or not an unused memory is present by reference to the memory usage information MJ of each of the n number of the segment information items 123 included in the address conversion table 122.

Here, the storage device 200 includes three memories 210. In this case, for example, when the memory usage information MJ of each of the n number of the segment information items 123 indicates “1” or “2,” the memory usage monitoring circuit 152 determines that the memory 210c is unused. In short, the memory usage monitoring circuit 152 determines that the unused memory is present.

When determining that the unused memory is present, the memory usage monitoring circuit 152 transmits memory nonusage information to the power control circuit 160. The memory nonusage information indicates a code (information) for identifying an unused memory. The code is expressed as a binary value, for example.

The code is expressed as one of “00,” “01,” and “10,” for instance. For example, “00,” “01” and “10” are codes for identifying the memories 210a, 210b, and 210c respectively.

It is to be noted that a code for identifying an unused memory is not limited to the above-mentioned code, but may be an alphabet or the like.

More specifically, the power control circuit 160 continually determines whether or not the unused memory is present, by receiving the memory nonusage information from the memory usage monitoring circuit 152 that has performed the memory usage monitoring processing.

As will hereinafter be described in detail, the power control circuit 160 performs power consumption control processing for controlling power consumption.

### (Processing by Memory Control System Using Two Memories)

Next, processing performed by the memory control system 100 is described. Hereinafter, for ease of explanation, two memories 210 is are connected to the memory control system 100. Hereinafter, a configuration of the memory control system 100 using the two memories is also referred to as a two-memory configuration.

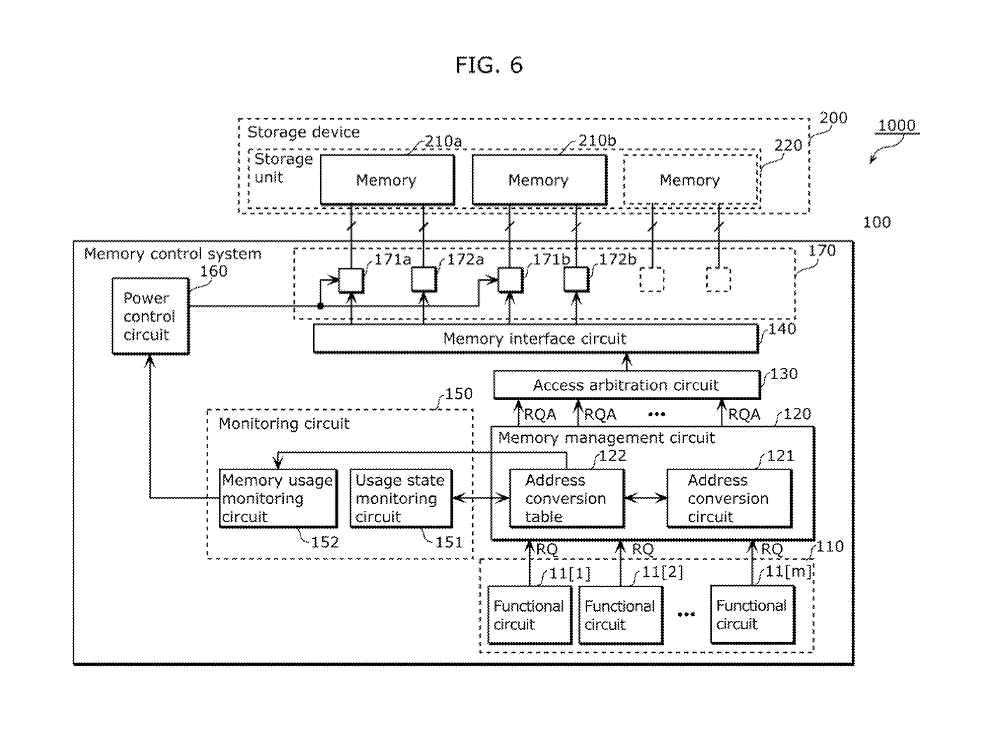

In the memory control system 100 having the two-memory configuration, as illustrated in FIG. 6, the storage device 200 includes only the memories 210a and 210b. In other words, the two memories 210 are connected to the memory control system 100 having the two-memory configuration.

First, the following describes processing for setting memory usage information MJ (hereinafter also referred to as memory usage setting processing) in the memory control system 100 having the two-memory configuration.

In the memory control system 100 having the two-memory configuration, usage priority levels are assigned so that the usage priority levels decrease in an order of the memory 210a and the memory 210b. In short, between the memory 210a and the memory 210b, the memory 210a has the highest priority level. In addition, the memory usage information MJ indicates “1” or “2.”

Moreover, in the memory control system 100 having the two-memory configuration, the I/O unit 170 includes only the I/O circuits 171a, 171b, 172a, and 172b. Furthermore, the storage unit 220 in FIG. 2 includes all of the storage regions of the memory 210a and all of the storage regions of the memory 210b.

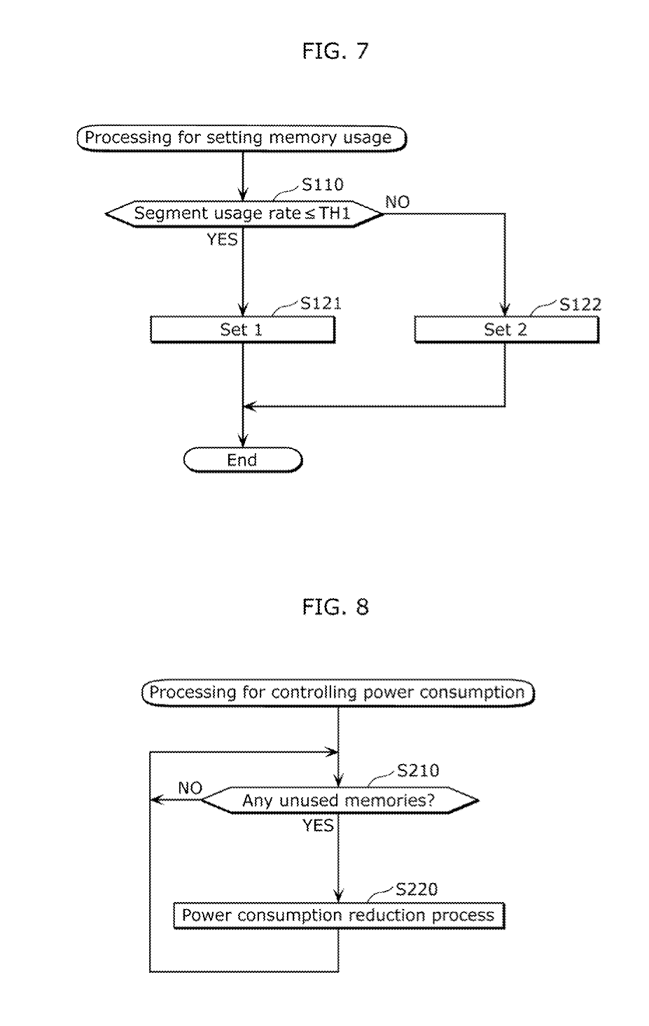

FIG. 7 is a flow chart for the memory usage setting processing. The usage state monitoring circuit 151 performs the memory usage setting processing every time segment information is changed in the address conversion table 122. In other words, the usage state monitoring circuit 151 performs the memory usage setting processing every time the address conversion circuit 121 receives one access request RQ from the function unit 110.

It is to be noted that the usage state monitoring circuit 151 performs the memory usage setting processing and the aforementioned usage state monitoring processing in parallel.

In reference to FIG. 7, the usage state monitoring circuit 151 determines whether or not the latest segment usage rate is less than or equal to a first threshold value TH1 in step S110. The first threshold value TH1 is ⅜, for instance. It is to be noted that the first threshold value TH1 is not limited to ⅜, but may be a value in a range of 2/8 to ⅜, for example. In short, the first threshold value TH1 is a value less than 0.5.

A segment usage rate is expressed in (the number of valid segments)/n. Specifically, the latest segment usage rate is a ratio of the number of the latest valid segments to n.

More specifically, the usage state monitoring circuit 151 determines whether or not a predetermined condition for usage states of memories is satisfied. The predetermined condition is a condition that a value dependent on the number of the latest valid segments is less than or equal to the predetermined first threshold value TH1. The value dependent on the number of the latest valid segments is the ratio of the number of the latest valid segments to n (segment usage rate).

It is to be noted that the usage state monitoring circuit 151 may determine whether or not the number of valid segments is less than or equal to the first threshold value TH1 in step S110. In this case, the first threshold value TH1 is n×⅜, for instance.

When YES in step S110, the processing proceeds to step S121. In contrast, when NO in step S110, the processing proceeds to step S122.

The usage state monitoring circuit 151 sets to “1” a value indicated by the memory usage information MJ included in the changed latest segment information in step S121.

The usage state monitoring circuit 151 sets to “2” the value indicated by the memory usage information MJ included in the changed latest segment information in step S122.

Stated differently, the memory usage setting processing is processing for determining, among the memories, a memory to which access is permitted. Specifically, the usage state monitoring circuit 151 (monitoring circuit 150) determines, among the memories, the memory to which access is permitted, based on the usage states of the memories.

That is to say, in the memory usage setting processing, every time the usage state monitoring circuit 151 (monitoring circuit 150) performs processing for accessing one of segments, the usage state monitoring circuit 151 updates identification information included in segment information corresponding to a segment to be accessed so that the identification information identifies, among the memories, a memory having a higher priority level as the number of the valid segments is smaller. The identification information is memory usage information MJ. With this, among the memories, the memory to which access is permitted is determined.

Moreover, the memory usage setting processing is processing for determining, among the memories, the memory to which access is permitted, based on the segment usage rate. In other words, the usage state monitoring circuit 151 (monitoring circuit 150) determines, among the memories, the memory to which access is permitted, based on the number of the valid segments among the n number of the segments.

When the memory usage information MJ indicates “1,” a size of a segment SG corresponding to segment information 123 including the memory usage information MJ is equivalent to a capacity of one storage region C10. The storage region C10 is a storage region C10 in the memory 210a having the highest priority level. As stated above, when the memory usage information MJ indicates “1,” in a process for accessing the segment corresponding to the memory usage information MJ, only the memory 210a having the highest priority level is accessed, but the memory 210b is not accessed.

When the memory usage information MJ indicates “2,” a size of a segment SG corresponding to segment information 123 including the memory usage information MJ is equivalent to a total capacity of two storage regions C10. The two storage regions C10 are a storage err region C10 in the memory 210a and a storage region C10 in the memory 210b, respectively.

When the memory usage information MJ indicates “2,” access to the both memories 210a and 210b is permitted. When the memory usage information MJ indicates “2,” in a process for accessing the segment corresponding to the memory usage information M), the both memories 210a and 210b are accessed.

The address conversion circuit 121 performs the above-mentioned segment size setting processing, using the value indicated by the latest memory usage information MJ updated in the memory usage setting processing.

It is to be noted that the usage state monitoring circuit 151 further performs a determination process independently of other processes.

In the determination process, the usage state monitoring circuit 151 performs the process of step S110. When the determination in step S110 is YES, the usage state monitoring circuit 151 transmits to the power control circuit 160 a condition achievement notification indicating that the predetermined condition for the usage states of the memories has been satisfied.

The power control circuit 160 continually determines whether or not the predetermined condition has been satisfied, by receiving the condition achievement notification.

Next, power consumption control processing performed by the power control circuit 160 is described. The power control circuit 160 continually performs the power consumption control processing independently of other processing. The power consumption control processing is the power control method according to this embodiment.

FIG. 8 is a flow chart for the power consumption control processing.

The power control circuit 160 determines whether or not the predetermined condition for the usage states of the memories has been satisfied, and whether or not an unused memory is present in step S210. Specifically, when receiving the memory nonusage information from the memory usage monitoring circuit 152, the power control circuit 160 determines that the unused memory is present.

When YES in step S210, the processing proceeds to step S220. In contrast, when NO in step S210, the process of step S210 is performed again.

In other words, when the predetermined condition for the usage states of the memories has been satisfied, and the unused memory is present among the memories, the power control circuit 160 performs a power consumption reduction process of step S220.

The power control circuit 160 performs the power consumption reduction process in step S220.

The power consumption reduction process is a process for causing a target circuit that is an I/O circuit connected to the unused memory to consume less power than an I/O circuit other than the target I/O circuit among the I/O circuits.

Specifically, in the power consumption reduction process, the power control circuit 160 transmits a stop instruction to the I/O circuit 171 connected to the memory identified by the received latest memory nonusage information. The stop instruction is an instruction to stop power supply to the I/O circuit 171. In short, the stop instruction is an instruction to disable the I/O circuit 171.

Here, the memory nonusage information identifies the memory 210b. In this case, in the power consumption reduction process, the power control circuit 160 transmits the stop instruction to the I/O circuit 171b.

Upon receiving the stop instruction, the power control unit 183 of the I/O circuit 171b goes into the OFF state. With this, the external power source and the differential output amplifier 181 and the differential amplifier 182 in the I/O circuit 171b are electrically disconnected. As a result, the power supply to the differential output amplifier 181 and the differential amplifier 182 is stopped. In short, the differential output amplifier 181 and the differential amplifier 182 are disabled.

More specifically, the power consumption reduction process is a process in which the power control circuit 160 controls the target I/O circuit (I/O circuit 171) so that circuits (the differential output err amplifier 181 and the differential amplifier 182) included in the I/O circuit, the target I/O circuit, are disabled.

Then, the power consumption reduction process is completed, and the process of step S210 is performed again.

It is to be noted that when each of the differential output amplifier 181 and the differential amplifier 182 has the aforementioned power down function, the following process is performed in the power consumption reduction process.

Upon receiving the stop instruction, the power control unit 183 of the I/O circuit 171b powers down the differential output amplifier 181 and the differential amplifier 182. With this, the power consumption by the differential output amplifier 181 and the differential amplifier 182 can be stopped.

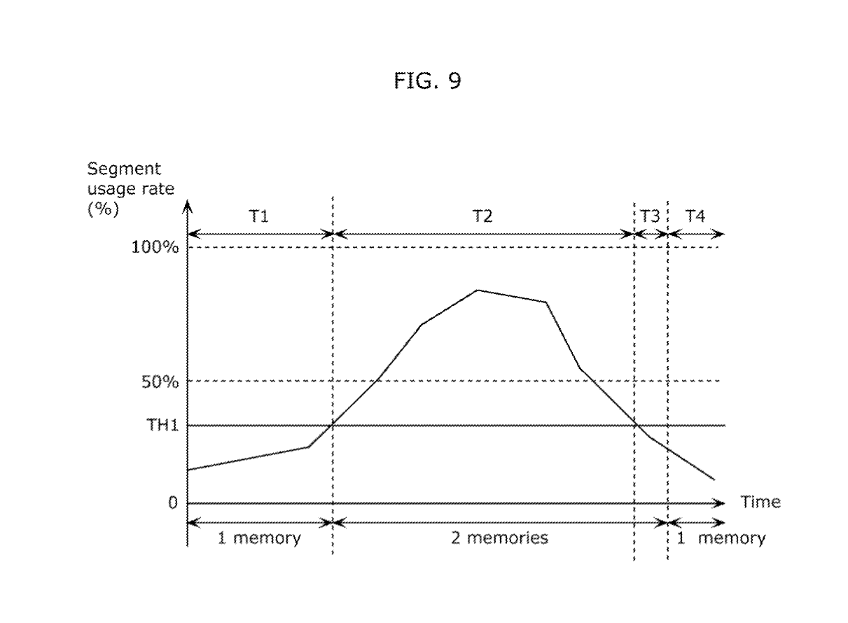

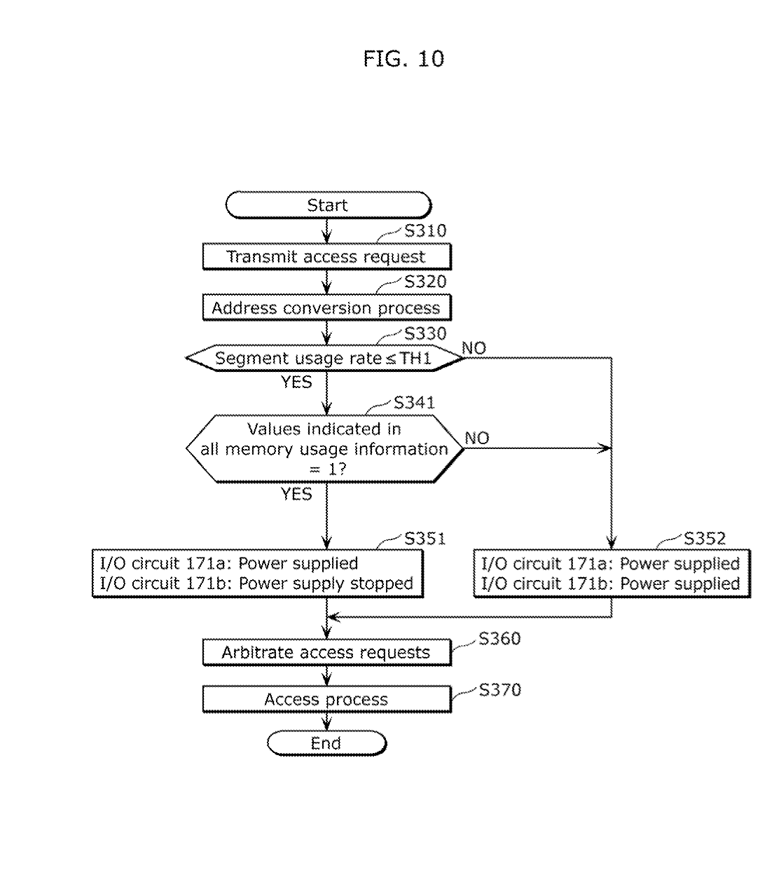

The following describes exemplary operations of the memory control system 100 having the configuration in FIG. 6, with reference to FIG. 9 and FIG. 10.

FIG. 9 is a graph for illustrating exemplary operations performed by the memory control system 100 having the two-memory configuration. FIG. 9 illustrates an exemplary state of a segment usage rate that changes with time.

In FIG. 9, the vertical axis represents a segment usage rate. “TH1” represents the aforementioned first threshold value TH1, A numeral illustrated in FIG. 9 is the number of memories used in a period corresponding to the numeral. For instance, two memories are used in periods T2 and T3.

Here, in the memory control system 100, the functional circuit 11 transmits an access request RQ to the memory management circuit 120, and the above-mentioned usage state monitoring processing, memory usage monitoring processing, power consumption control processing in FIG. 8, and determination process are performed.

FIG. 10 is a flow chart for illustrating exemplary operations of the memory control system 100 having the two-memory configuration. It is to be noted that power is supplied to each of the I/O circuits 171a, 171b, 172a, and 172b immediately after the memory control system 100 starts to operate.

Processing in FIG. 10 is performed every time the functional circuit 11 issues the access request RQ.

First, at least one functional circuit 11 transmits the access request RQ to the memory management circuit 120 (S310).

Then, the address conversion circuit 121 performs the aforementioned address conversion process (S320). Subsequently, the aforementioned validity setting processing and the memory usage setting processing in FIG. 7 are sequentially performed. The segment usage rate is less than or equal to the first threshold value TH1 in the period T1 in FIG. 10. For this reason, the determination in step S110 (S330) is YES, and the aforementioned process of step S121 and a process of step S341 are performed in the period T1.

To put it another way, only the memory 210a is used, because the segment usage rate is low immediately after the memory control system 100 starts to operate as in the period T1.

The aforementioned segment size setting processing is performed after the memory usage setting processing. Then, as stated above, the address conversion circuit 121 generates and transmits the access request RQA to the access arbitration circuit 130.

Moreover, by performing the memory usage monitoring processing, it is determined that the unused memory is present (YES in S210 in FIG. 8), and the power consumption reduction process is performed in the period T1.

Furthermore, values indicated by all memory usage information items MJ corresponding to all valid segment information items are “1” in the period T1. Specifically, the memory usage information MJ of each of all the valid segment information items included in the address conversion table 122 indicate “1” in the period T1. For this reason, the determination in step S341 is YES, and a process of step S351 is performed.

In the power consumption reduction process, the power supply to the I/O circuit 171b is stopped. It is to be noted that the power supply to the I/O circuit 171a is continued (S351).

Subsequently, as stated above, the access arbitration circuit 130 arbitrates the received access requests RQA (S360).

Then, as stated above, the memory interface circuit 140 performs the aforementioned access process (S370).

Here, a period T2 in FIG. 9 is a period in which the segment usage rate is greater than the first threshold value TH1.

The following describes processing in the period T2 after the segment usage rate becomes greater than the first threshold value TH1.

First, as before, the processes of steps S310 and S320 are performed.

In this case, the determination in step S110 of the memory usage setting processing in FIG. 7 is YES, and the process of step S122 is performed. With this process, a value indicated by memory usage information MJ is set to “2.” Stated differently, access to both the memories 210a and 210b is permitted. In short, both the memories 210a and 210b are used in the period T2. Moreover, the determination in step S330 is NO, and the processing proceeds to step S352

Furthermore, by performing the memory usage monitoring processing, it is determined that the unused memory is not present in the period T2 (NO in S210 in FIG. 8).

Moreover, values indicated by all memory usage information items MJ corresponding to all valid segment information items are not “1” in the period T2. Specifically, the memory usage information MJ of each of all the valid segment information items included in the address conversion table 122 indicates “1” or “2” in the period T2.

When a disabled I/O circuit is present, the power control circuit 160 performs an operation start process in step S352. Here, as an example, the I/O circuit 171b is disabled.

In this case, in the operation start process, an operation start instruction is transmitted to the I/O circuit 171b. The operation start instruction is an instruction to cause a disabled I/O circuit to operate. In other words, the operation start instruction is an instruction to supply power to the disabled I/O circuit.

Upon receiving the operation start instruction, the power control unit 183 of the I/O circuit 171b goes into the ON state. With this, the external power source and the differential output amplifier 181 and the differential amplifier 182 in the I/O circuit 171b are electrically connected. As a result, the power is supplied to the differential output amplifier 181 and the differential amplifier 182 in the I/O circuit 171b. In short, the differential output amplifier 181 and the differential amplifier 182 operate.

It is to be noted that when each of the differential output amplifier 181 and the differential amplifier 182 has the aforementioned power down function, the following process is performed in the operation start process.

Upon receiving the operation start instruction, the power control unit 183 of the I/O circuit 171b causes the differential output amplifier 181 and the differential amplifier 182 to operate.

With this, the power is supplied to the disabled I/O circuit 171b. Specifically, the power is supplied to the I/O circuits 171a and 171b (S352).

It is to be noted that when the disabled I/O circuit is not present, the power control circuit 160 does not perform the operation start process.

Here, the processes of steps S360 and S370 are the same as those described above, and thus the detailed description thereof is not repeated.

It is to be noted that when a new valid segment is generated in the period T2, segment information 123 corresponding to the valid segment includes memory usage information MJ indicating “2.” Specifically, the segment information 123 includes information for permitting the access to both the memories 210a and 210b based on the access request RQ generated in the period T2.

To put it another way, when the new valid segment is generated, both the memories 210a and 210b are accessed in the period T2.

The following describes processing in a period T3 in FIG. 9. The period T3 is a period in which the segment usage rate is less than or equal to the first threshold value TH 1, and an unused memory is not present.

At the moment when the segment usage rate becomes less than in or equal to the first threshold value TH1, processing for not using the memory 210b is not performed. The processing is specifically described below.

The process of step S121 in the memory usage setting processing in FIG. 7 is performed in the period T3. Only the memory 210a is accessed based on the access request RQ issued after the process of step S121 is performed in the period T3.

A segment corresponding to the access request RQ issued after the process of step S121 is performed is a segment having a capacity of one storage region C10 in the period T3. Stated differently, the segment having the capacity of the storage region C10 is increased by the number of access requests RQ issued after the process of step S121 is performed in the period T3.

It is to be noted that when a new valid segment is generated in the period T3, segment information 123 corresponding to the valid segment includes memory usage information MJ indicating “1.” Specifically, the segment information 123 includes information for permitting the access to only the memory 210a based on the access request RQ generated in the period T3.

Moreover, the determination in step S330 is YES in the period T3.

Furthermore, values indicated by all memory usage information items MJ corresponding to all valid segment information items are not “1” in the period T3. Specifically, the memory usage information MJ of each of all the valid segment information items included in the address conversion table 122 indicates “1” or “2” in the period T3. For this reason, the determination in step S341 is NO, and the process of step S352 is performed.

When the memory usage information. MJ of each of the n number of the segment information items 123 included in the address conversion table 122 comes to indicate “1,” the period T3 changes to a period T4.

The following describes processing in a period T4 in FIG. 9. The period T4 is a period in which the segment usage rate is less than or equal to the first threshold value TH1, and an unused memory is present.

Moreover, values indicated by all memory usage information items MJ corresponding to all valid segment information items are “1” in the period T4. Specifically, the memory usage information MJ of each of alt the valid segment information items included in the address is conversion table 122 indicates “1” in the period T4. For this reason, the determination in step S341 is YES, and the process of step S351 is performed.

The same processing as in the period T1 is performed in the period T4, and thus the detailed description thereof is not repeated. In other words, in the power consumption reduction process, the power supply to the I/O circuit 171a is stopped (S351).

As described above, in the memory control system 100 having the two-memory configuration, the segment usage rate is always calculated, and the power consumption control processing is performed when the segment usage rate is Less than or equal to the first threshold value TH1, and the unused memory is present. In short, the power supply to the I/O circuit 171 connected to the unused memory is stopped. With this, it is possible to reduce the power consumption of the memory control system 100.

Moreover, the I/O circuit 171 connected to the unused memory is the differential I/O circuit that uses the differential signal. For this reason, it is possible to reduce the power consumption of the memory control system 100 more greatly when the power supply to the I/O circuit 171 is stopped than when the power supply to the I/O circuit that processes the single-ended signal is stopped.

It is to be noted that the unused memory is always supplied with power for holding data, and is always operating. Consequently, to make the unused memory operational, it is only necessary to supply power to the target I/O circuit, the I/O circuit 171 connected to the unused memory, so that the power consumption of the target I/O circuit becomes almost equal to that of the I/O circuit 171 other than the target I/O circuit.

To put it another way, it is possible to make the unused memory operational by only starting the power supply to the I/O circuit 171 connected to the unused memory. Specifically, it is possible to make the unused memory operational in less time than the conventional technique that stops power supply to a memory. For this reason, it is possible to decrease as much as possible a time until the unused memory that is inaccessible is made operational.

Thus, it is possible to decrease as much as possible the time until the inaccessible memory is made operational and to reduce the power consumption of the memory control system 100.

As a result, it is possible to efficiently reduce the power consumption of the memory control system 100.

Moreover, it is possible to reduce the power consumption of the I/O circuit 171 by dynamically performing or stopping the power supply to the I/O circuit 171 connected to the memory.

### (Processing by Memory Control System Using Three Memories)

Next, processing performed by the memory control system 100 is described. Here, the memory control system 100 has the configuration in FIG. 1. In other words, the three memories 210 are connected to the memory control system 100. Hereinafter, a configuration of the memory control system 100 using the three memories is also referred to as a three-memory configuration.

In this case, as an example, usage priority levels are assigned so that the usage priority levels decrease in an order of the memory 210a, the memory 210b, and the memory 210c, as stated above. In addition, memory usage information MJ indicates one of “1” to “3.” Furthermore, the storage unit 220 in FIG. 2 includes all of the storage regions of the memory 210a, all of the storage regions of the memory 210b, and all of the storage regions of the memory 210c.

First, the following describes processing for setting memory usage information MJ (hereinafter also referred to as memory usage setting processing A) in the memory control system 100 having the three-memory configuration.

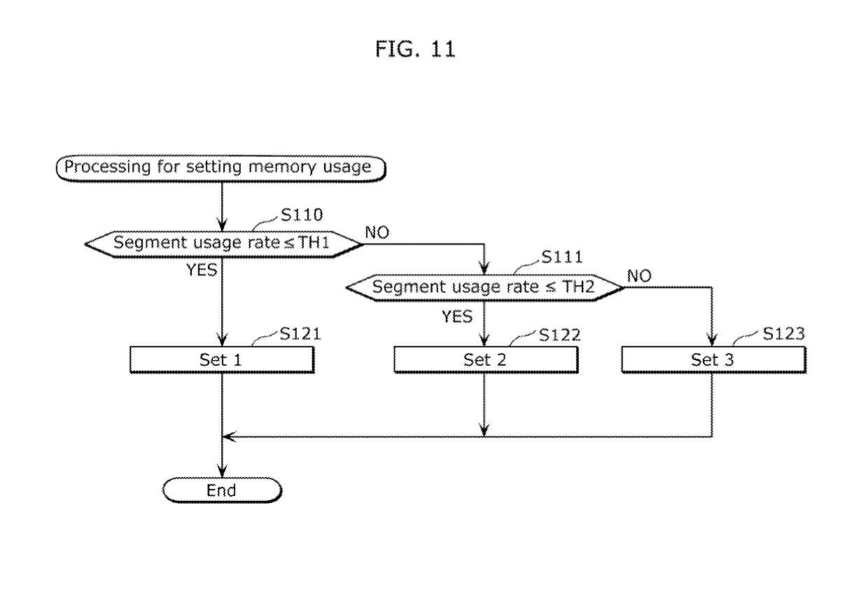

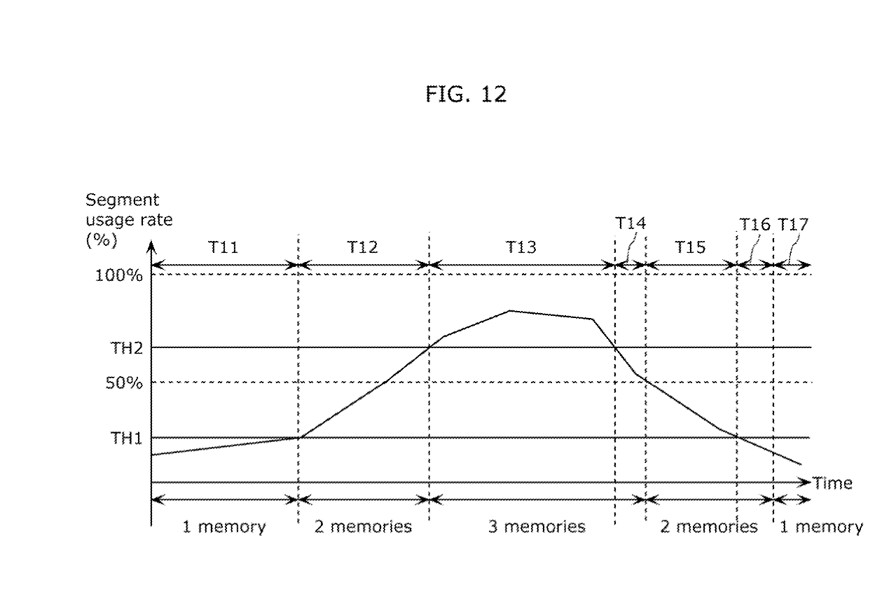

FIG. 11 is a flow chart for the memory usage setting processing A. Processes indicated by the same step numbers in FIG. 11 as those in FIG. 7 are the same as the processes described above, and thus the detailed description thereof is not repeated.

When NO in step S110, a process of step S111 is performed.

The usage state monitoring circuit 151 determines whether or not the latest segment usage rate is greater than TH1 and less than or equal to a predetermined second threshold value TH2 in step S111.

The second threshold value TH2 is greater than the first is threshold value TH1. The second threshold value TH2 is ⅝, for instance. It is to be noted that the second threshold value TH2 is not limited to ⅝, but may be a value in a range of ⅝ to ⅞, for example.

When YES in step S111, the processing proceeds to step S122. In contrast, when NO in step S111, the processing proceeds to step S123.

The usage state monitoring circuit 151 sets to “3” a value indicated by memory usage information MJ included in the changed latest segment information in step S123.

When the memory usage information MJ indicates “3,” access to the memories 210a, 210b, and 210c is permitted. When the memory usage information MJ indicates “3,” in a process for accessing a segment corresponding to the memory usage information MJ, the memories 210a, 210b, and 210c are accessed.

The address conversion circuit 121 performs the above-mentioned segment size setting processing, using the value indicated by the latest memory usage information MJ updated in the memory usage setting processing A.

It is to be noted that the usage state monitoring circuit 151 performs the aforementioned determination process. With this, the power control circuit 160 continually determines whether or not the predetermined condition has been satisfied, by receiving a condition achievement notification.

The following describes exemplary operations of the memory control system 100 having the configuration in FIG. 1, with reference to FIG. 12.

FIG. 12 is a graph for illustrating exemplary operations of the memory control system 100 having the three-memory configuration. FIG. 12 illustrates an exemplary state of a segment usage rate that changes with time.

In FIG. 12, the vertical axis represents a segment usage rate. “TH2” represents the second threshold value TH2. A numeral illustrated in FIG. 12 is the number of memories used in a period corresponding to the numeral.

Here, in the memory control system 100, the functional circuit 11 transmits an access request RQ to the memory management circuit 120, and the above-mentioned usage state monitoring processing, memory usage monitoring processing, power consumption control processing in FIG. 8, and determination process are performed.

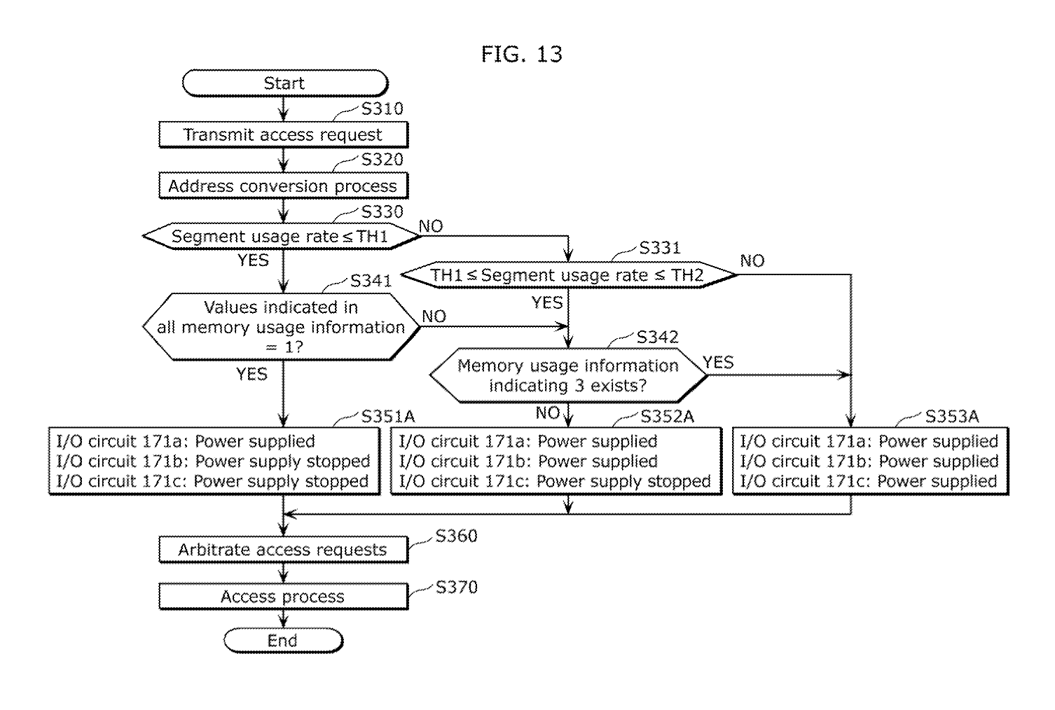

FIG. 13 is a flow chart for illustrating exemplary operations of the memory control system 100 having the three-memory configuration. It is to be noted that power is supplied to each of the I/O circuits 171a, 171b, 172a, 172b, 171c, and 172c immediately after the memory control system 100 starts to operate.

Processing in FIG. 13 is performed every time the functional circuit 11 issues the access request RQ.

Processes indicated by the same step numbers in FIG. 13 as those in FIG. 10 are the same as the processes performed by the memory control system 100 having the two-memory configuration, and thus the detailed description thereof is not repeated.

First, at least one functional circuit 11 transmits the access request RQ to the memory management circuit 120 (S310).

Then, the address conversion circuit 121 performs the aforementioned address conversion process (S320). Subsequently, the aforementioned validity setting processing and the memory usage setting processing A in FIG. 11 are sequentially performed. The segment usage rate is less than or equal to the first threshold value TH1 in a period T11 in FIG. 12. For this reason, the determination in step S110 (S330) is YES, and the aforementioned process of step S121 and process of step S341 are performed in the period T11.

As stated above, only the memory 210a is used, because the segment usage rate is low immediately after the memory control system 100 starts to operate (the period T11).

The aforementioned segment size setting processing is performed after the memory usage setting processing A. Then, as stated above, the address conversion circuit 121 generates and transmits the access request RQA to the access arbitration circuit 130.

Moreover, by performing the memory usage monitoring processing, it is determined that an unused memory is present (YES in S210 in FIG. 8), and the power consumption reduction process is performed in the period T11.

Moreover, values indicated by all memory usage information items MJ corresponding to all valid segment information items are “1” in the period T11. Specifically, the memory usage information MJ of each of all the valid segment information items included in the address conversion table 122 indicates “1” in the period T11. For this reason, the determination in step S341 is YES, and a process of step S351A is performed.

The power consumption reduction process is performed in step S351A. In the power consumption reduction process (S351A), the power control circuit 160 transmits a stop instruction to the I/O circuits 171b and 171c.

With this, as stated above, the I/O circuit 171c also operates in the same manner as the I/O circuit 171b receiving the stop instruction. Specifically, power supply to the differential output amplifier 181 and the differential amplifier 182 included in each of the I/O circuits 171b and 171c is stopped. The differential output amplifier 181 and the differential amplifier 182 included in each of the I/O circuits 171b and 171c are disabled. It is to be noted that power supply to the I/O circuit 171a is continued (S351A).

In the process of step S351A, the power supply to the I/O circuits 171b and 171c is stopped.

The processes of steps S360 and S370 are the same as those described above, and thus the detailed description thereof is not repeated.

Here, a period T12 in FIG. 12 is a period in which the latest segment usage rate is greater than the first threshold value TH1 and less than or equal to the second threshold value TH2.

The following describes processing in the period T12.

First, as before, the processes of steps S310 and S320 are performed.

In this case, the determination in step S111 of the memory usage setting processing A in FIG. 11 is YES, and the process of step S122 is performed. With this process, a value indicated by memory usage information MJ is set to “2.” Stated differently, access to both the memories 210a and 210b is permitted. In short, both the memories 210a and 210b are used in the period T12.

Moreover, the determination in step S330 is NO, and the determination in step S331 is YES in the period T12. Then, the processing proceeds to step S342.

Moreover, by performing the memory usage monitoring processing, it is determined that the unused memory is present (YES in S210 in FIG. 8), and the power consumption reduction process in step S220 is performed in the period T12.

Moreover, the values indicated by all the memory usage information items MJ corresponding to all the valid segment information items are “1” or “2” in the period T12. Specifically, the memory usage information MJ of each of all the valid segment information items included in the address conversion table 122 indicates “1” or “2” in the period T12. In short, there is no memory usage information indicating “3” in the address conversion table 122 in the period T12.

For this reason, the determination in step S342 is NO, and a process of step S352A is performed.

The power consumption reduction process is performed in step S352A. In the power consumption reduction process, the power control circuit 160 transmits the stop instruction to the I/O circuit 171c.

With this, as before, power supply to the differential output amplifier 181 and the differential amplifier 182 in the I/O circuit 171c is stopped. The differential output amplifier 181 and the differential amplifier 182 in the I/O circuit 171c are disabled.

Moreover, when a disabled I/O circuit other than the I/O circuit 171c is present, the power control circuit 160 performs an operation start process in step S352A. Here, as an example, the I/O circuit 171b is disabled.

In this case, in the operation start process, the power control circuit 160 transmits an operation start instruction to the I/O circuit 171b. A process by the I/O circuit 171b receiving the start operation instruction is the same as the process of step S352, and thus the detailed description thereof is not repeated. With this, the power is supplied to the differential output amplifier 181 and the differential amplifier 182 in the I/O circuit 171b.

It is to be noted that when the disabled I/O circuit other than the I/O circuit 171c is not present, the power control circuit 160 does not perform the operation start process.

It is to be noted that the power supply to the I/O circuit 171a is continued. In other words, the process of step S352A allows the I/O circuit 171b to operate to make the memory 210b operational. In short, the memories 210a and 210b are operational immediately after the process of step S352A.

It is to be noted that the processes of steps S360 and S370 are the same as those described above, and thus the detailed description thereof is not repeated.

Here, a period 113 in FIG. 12 is a period in which the latest segment usage rate is greater than the second threshold value TH2, and an unused memory is not present.

The following describes processing in the period 113.

First, as before, the processes of steps S310 and S320 are performed.

In this case, the determination in step S111 of the memory usage setting processing A in FIG. 11 is NO, and the process of step S123 is performed. With this process, a value indicated by memory usage information MI is set to “3.” Stated differently, access to the memories 210a, 210b, and 210c is permitted. In short, the memories 210a, 210b, 210c are used in the period T13.

Moreover, the determination in step S330 is NO, and the determination in step S331 is NO. Then, the processing proceeds to step S353A.

It is to be noted that at the moment when a process of step S353A is started, the power control circuit 160 does not receive memory nonusage information, because the unused memory is not present (NO in S210). For this reason, the power control circuit 160 performs a process for using the memories 210a, 210b, and 210c is (S353A).

When a disabled I/O circuit is present, the power control circuit 160 performs an operation start process in step S353A. In the operation start process, the power control circuit 160 transmits an operation start instruction to the I/O circuit 171c. A process by the I/O circuit 171c receiving the start operation instruction is the same as the process by the I/O circuit 171b receiving the start operation instruction, and thus the detailed description thereof is not repeated. With this, the power is supplied to the differential output amplifier 181 and the differential amplifier 182 in the I/O circuit 171c.

In other words, the process of step S353A allows the I/O circuit 171c to operate to make the memory 210c operational. In short, the memories 210a, 210b, and 210c are operational immediately after the process of step S353A.

It is to be noted that the processes of steps S360 and S370 are the same as those described above, and thus the detailed description thereof is not repeated.

The following describes processing in a period T14 in FIG. 12. The period T14 is a period in which the segment usage rate is less than or equal to the second threshold value TH2, and an unused memory is not present.

At the moment when the segment usage rate becomes less than or equal to the second threshold value TH2, processing for not using the memory 210c is not performed in the period T14

First, as before, the processes of steps S310 and S320 are performed.

In this case, the determination in step S111 of the memory usage setting processing A in FIG. 11 is YES, and the process of step S122 is performed. With this process, a value indicated by memory usage information. MJ is set to “2.” Stated differently, access to the memories 210a and 210b is permitted.

It is to be noted that when a new valid segment is generated the period T14, segment information 123 corresponding to the valid segment includes memory usage information MJ indicating “2.” Specifically, the segment information 123 includes information for permitting the access to only the memories 210a and 210b based on an access request RQ generated in the period T14.

Moreover, by performing the memory usage monitoring processing, it is determined that the unused memory is not present in the period 114 (NO in S210 in FIG. 8).

Furthermore, the determination in step S330 is NO, and the determination in step S331 is YES in the period T14. Then, the processing proceeds to step S342.

Moreover, the values indicated by all the memory usage information items MJ corresponding to all the valid segment information items are one of “1” to “3” in the period T14. Specifically, valid segment information including the memory usage information MJ indicating “3” is present among all the valid segment information items included in the address conversion table 122. For this reason, the determination in step S342 is YES, and the process of step S353A is performed.

When the memory usage information MJ indicating “3” is not present in the address conversion table 122, the period T14 changes to a period T15.

The following describes processing in the period T15 in FIG. 12. The period T15 is a period in which the segment usage rate is greater than the first threshold value TH1 and less than or equal to the second threshold value TH2, and an unused memory is present.

The same processing as in the period T12 is performed in the period T15, and thus the detailed description thereof is not repeated.

Then, the segment usage rate further decreases, and when the segment usage rate becomes less than or equal to the first threshold value TH1, the period T15 changes to a period T16.

The period T16 is a period in which the segment usage rate is less than or equal to the first threshold value TH1, and the values indicated by all the memory usage information items MJ corresponding to all the valid segment information items are not That the values indicated by all the memory usage information items MJ corresponding to all the valid segment information items are not “1” means that two unused memories are not present.

In this case, the determination in step S341 is NO, the determination in step S342 is NO, and the process of step S352A is performed.

The same processing as in the period T12 is performed in the period T16, and thus the detailed description thereof is not repeated.

It is to be noted that when a new valid segment is generated in the period T16, segment information 123 corresponding to the valid segment includes memory usage information MJ indicating “1.” Specifically, the segment information 123 includes information for permitting the access to only the memory 210a based on an access request RQ generated in the period T15.

Then, the segment usage rate further decreases, and when the values indicated by all the memory usage information items MJ become 1, the period T16 changes to a period T17.

The period T17 is a period in which the segment usage rate is less than or equal to the first threshold value TH1, and the values indicated by all the memory usage information items MJ corresponding to all the valid segment information items are “1.” The same processing as in the period T11 is performed in the period T17, and thus the detailed description thereof is not repeated. In this case, the process of step S351A is performed.

As described above, even when the number of the memories connected to the memory control system 100 is at least three, it is possible to dynamically reduce the power consumption of the I/O circuit by providing the threshold values according to the segment usage rate. Specifically, the memory control system 100 having the three-memory configuration also provides the same advantageous effects as the memory control system 100 having the two-memory configuration.

To put it another way, it is possible to decrease as much as possible the time until the inaccessible memory is made operational and to reduce the power consumption of the memory control system 100.

### Embodiment 2

In Embodiment 2, the maximum memory capacity used in processing performed by each functional circuit is utilized.

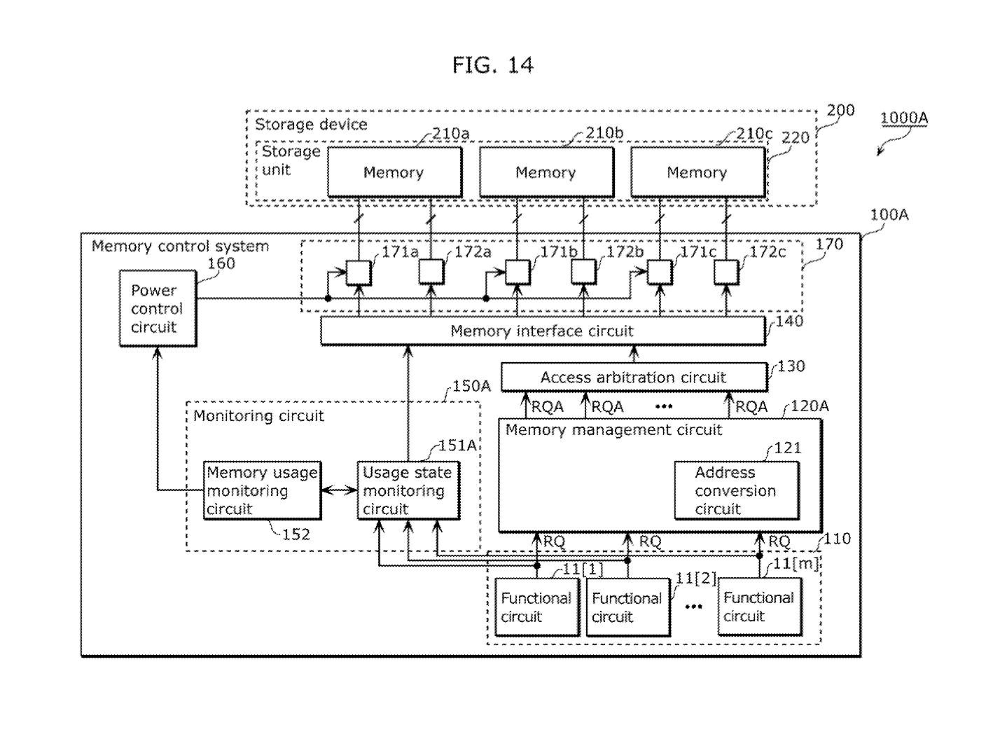

FIG. 14 is a block diagram illustrating a configuration of a processing device 1000A according to Embodiment 2.

As illustrated in FIG. 14, the processing device 1000A differs from the processing device 1000 in FIG. 1 in including a memory control system 100A instead of the memory control system 100. The other structural element of the processing device 1000A is the same as that of the processing device 1000, and thus the detailed description thereof is not repeated.

The memory control system 100A differs from the memory control system 100 in including a memory management circuit 120A instead of the memory management circuit 120, and a monitoring circuit 150A instead of the monitoring circuit 150. The other structural elements of the memory control system 100A are the same as those of the memory control system 100, and thus the detailed description thereof is not repeated.

The memory management circuit 120A differs from the memory management circuit 120 in not including the address conversion table 122. The other structural element of the memory management circuit 120A is the same as that of the memory management circuit 120, and thus the detailed description thereof is not repeated.

The monitoring circuit 150A differs from the monitoring circuit 150 in including a usage state monitoring circuit 151A instead of the usage state monitoring circuit 151. In addition, the monitoring circuit 150A differs from the monitoring circuit 150 in not including the address conversion table 122. The other structural element of the monitoring circuit 150A is the same as that of the monitoring circuit 150, and thus the detailed description thereof is not repeated.

The monitoring circuit 150A previously stores, in association with each of the functional circuits 11, the maximum memory capacity used in predetermined processing performed by each functional circuit 11. For instance, the maximum memory capacity in processing A performed by the functional circuit 11[1] is 512 kilobytes.

It is to be noted that as with Embodiment 1, a segment SG to be accessed in the storage unit 220 is previously assigned to each of the functional circuits 11. For this reason, the same segment is not accessed by each functional circuit 11.

Each functional circuit 11 transmits an access request RQ to the memory management circuit 120A and the usage state monitoring circuit 151A when a target segment needs to be accessed during execution of processing corresponding to the functional circuit 11.

In this embodiment, each functional circuit 11 transmits a processing completion signal to the usage state monitoring circuit 151A when the processing corresponding to the functional circuit 11 is completed.

As with Embodiment 1, the address conversion circuit 121 performs the address conversion process using the address conversion table 122 outside of the memory control system 100A and not shown, and thus the detailed description thereof is not repeated. It is to be noted that in this embodiment, the address conversion circuit 121 does not perform the validity setting processing and the invalidity setting processing. In addition, it is not necessary to perform the address conversion process.

As with Embodiment 1, the address conversion circuit 121 transmits the access request RQA to the access arbitration circuit 130. It is to be noted that the access request RQA does not include a set segment size.

The access arbitration circuit 130 performs the same processing as in Embodiment 1, and thus the detailed description thereof is not repeated. The access arbitration circuit 130 transmits, to the memory interface circuit 140, access requests RQA in decreasing order of priority level.

Next, processing performed by the memory control system 100A is described. Hereinafter, for ease of explanation, two err memories 210 are connected to the memory control system 100A. Hereinafter, a configuration of the memory control system 100A using the two memories is also referred to as a two-memory configuration.

In the memory control system 100A having the two-memory configuration, the storage device 200 includes only the memories 210a and 210b.

In the memory control system 100A having the two-memory configuration, usage priority levels are assigned so that the usage priority levels decrease in an order of the memory 210a and the memory 210b. In short, between the memory 210a and the memory 210b, the memory 210a has the highest priority level.

Moreover, in the memory control system 100A having the two-memory configuration, the I/O unit 170 includes only the I/O circuits 171a, 171b, 172a, and 172b. Furthermore, the storage unit 220 in FIG. 2 includes all of the storage regions of the memory 210a and all of the storage regions of the memory 210b.

Every time the usage state monitoring circuit 151A receives the access request RQ from the functional circuit 11, the usage state monitoring circuit 151A performs usage state monitoring processing A. The usage state monitoring processing is processing for monitoring usage states of the memories 210 included in the storage device 200. In other words, the usage state monitoring circuit 151A continually monitors the usage sate of the storage unit 220.

Hereinafter, capacities of all the storage regions included in the storage unit 220 are also referred to as the maximum storage capacity.

In the usage state monitoring processing A, the usage state monitoring circuit 151A (monitoring circuit 150A) determines, among the memories, a memory to which access is permitted, based on the maximum memory capacity used in the processing performed by each functional circuit 11.

Specifically, in the usage state monitoring processing A, the usage state monitoring circuit 151A identifies a functional circuit 11 that transmitted a received access request RQ. Then, the usage state monitoring circuit 151A adds to a usage capacity the maximum memory capacity corresponding to the identified functional circuit 11. The usage capacity has an initial value of 0.

It is to be noted that when receiving a processing completion signal, the usage state monitoring circuit 151A identifies a functional circuit 11 that transmitted the processing completion signal. Then, the usage state monitoring circuit 151A subtracts the maximum memory capacity corresponding to the identified functional circuit 11, from the latest usage capacity.

Subsequently, the usage state monitoring circuit 151A calculates a memory usage rate using an equation of (usage capacity/maximum storage capacity). For example, when the usage capacity is 200 megabytes, and the maximum storage capacity is 1000 megabytes, the memory usage rate is 20%.

As stated above, every time the usage state monitoring circuit 151A receives the access request RQ, the usage state monitoring circuit 151A calculates the memory usage rate.

Moreover, every time the usage state monitoring circuit 151A receives the access request RQ, the usage state monitoring circuit 151A performs memory usage setting processing N.

Furthermore, the usage state monitoring circuit 151A performs the memory usage setting processing N and the usage state monitoring processing in parallel.

In the memory usage setting processing N, the usage state monitoring circuit 151A determines whether or not the latest memory usage rate is less than or equal to the first threshold value TH1.

When the latest memory usage rate is less than or equal to the first threshold value TH1, the usage state monitoring circuit 151A generates and stores memory usage information MJ indicating “1,” When the latest memory usage rate is greater than the first threshold value TH1, the usage state monitoring circuit 151A generates and stores memory usage information MJ indicating “2.”

It is to be noted that in the memory usage setting processing N, the usage state monitoring circuit 151A stores the memory usage information MJ and transmits the memory usage information MJ to the memory interface circuit.

The memory interface circuit 140 performs an access process N on a target segment corresponding to the received latest access request RQA, according to the latest access request RQA and the received latest memory usage information MJ.

For example, when the received memory usage information MJ indicates “1,” the memory interface circuit 140 accesses only the memory 210a according to the access request RQA in the access process N.

In addition, when the received memory usage information MJ indicates “2,” the memory interface circuit 140 accesses only the memories 210a and 210b according to the access request RQA in the access process N. It is to be noted that the process for accessing a memory is well-known, and thus the detailed description thereof is not repeated.

Moreover, the usage state monitoring circuit 151A further performs the same determination process as in Embodiment 1 independently of other processes. The following briefly describes the determination process.

In the determination process, the usage state monitoring circuit 151A determines whether or not the latest memory usage rate is less than or equal to the predetermined first threshold value TH1. More specifically, the usage state monitoring circuit 151A determines whether or not a predetermined condition for usage states of memories has been satisfied. The predetermined condition is a condition that the memory usage rate is less than or equal to the predetermined first threshold value TH1.

When the memory usage rate is less than or equal to the predetermined first threshold value TH1, the usage state monitoring circuit 151A transmits to the power control circuit 160 a condition achievement notification indicating that the predetermined condition for the usage states of the memories has been satisfied.

The power control circuit 160 continually determines whether or not the predetermined condition has been satisfied, by receiving the condition achievement notification.

The memory usage monitoring circuit 152 performs the memory usage monitoring processing N.

In the memory usage monitoring processing N, the memory usage monitoring circuit 152 determines, by reference to one or more memory usage information items MJ stored in the usage state monitoring circuit 151A, whether or not the predetermined condition for the usage states of the memories has been satisfied and whether or not an unused memory is present. Hereinafter, the memory usage information MJ stored in the usage state monitoring circuit 151A is also referred to as target memory usage information MJ.

Here, the storage device 200 includes two memories 210. In this case, for instance, when all of target memory usage information items MJ indicate “1,” the memory usage monitoring circuit 152 determines that the memory 210b is unused. In short, the memory usage monitoring circuit 152 determines that the unused memory is present.

When determining that the predetermined condition has been satisfied and that the unused memory is present, the memory usage monitoring circuit 152 transmits memory nonusage information to the power control circuit 160 as with Embodiment 1.

Next, the power control circuit 160 performs the power consumption control processing in FIG. 8 as with Embodiment 1. In other words, when the predetermined condition for the usage states of the memories is satisfied, and the unused memory is present among the memories, the power control circuit 160 performs the power consumption reduction process of step S220.

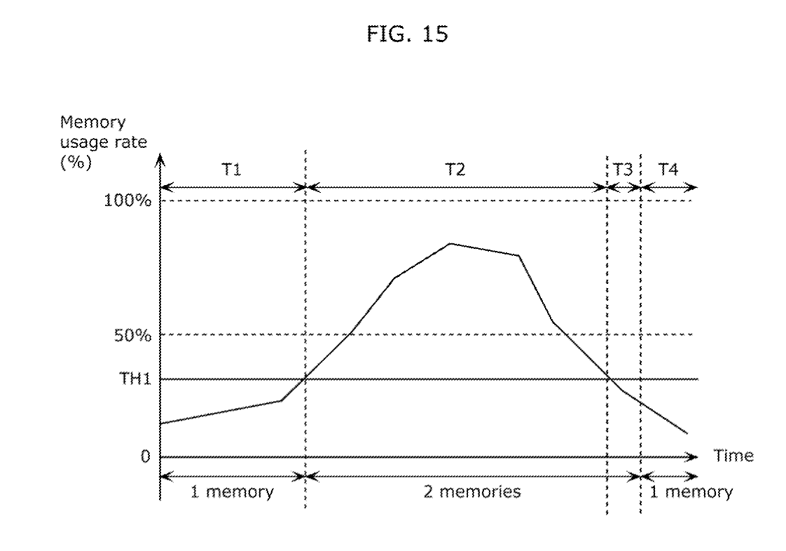

It is to be noted that FIG. 15 illustrates exemplary operations of the memory control system 100A having the two-memory configuration. FIG. 15 is a graph for illustrating the exemplary operations of the memory control system 100A having the two-memory configuration.

FIG. 15 differs from FIG. 9 in that the vertical axis represents a memory usage rate instead of the segment usage rate. The other elements of FIG. 15 are the same as those of FIG. 9, and thus the detailed description thereof is not repeated.

Specifically, as with the memory control system 100 having the tri two-memory configuration according to Embodiment 1, the memory control system 100A having the two-memory configuration performs or stops power supply to the I/O circuit 171 according to the first threshold value TH1 and the presence or absence of the unused memory.

It is to be noted that the memory control system 100A even having a three-memory configuration provides the same advantageous effects as the memory control system 100 having the three-memory configuration, by using the two threshold values as in FIG. 12.

As described above, the memory control system 100A according to this embodiment provides the same advantageous effects as in Embodiment 1. To put it another way, it is possible to decrease as much as possible the time until the inaccessible memory is made operational and to reduce the power consumption of the memory control system 100A.

In addition, according to this embodiment, it is possible to determine the memory usage rate without using the address conversion table 122.

### (Other Modifications)

Although the memory control system and the power control method according to the present disclosure have been described based on each of the embodiments, the present disclosure is not limited to these embodiments. The present disclosure includes modifications obtained by those skilled in the art modifying the embodiments without departing from the spirit of the present disclosure.

All the numeral values used in each embodiment are exemplary numerical values for specifically describing the present disclosure. In other words, the present disclosure is not limited to each of the numerical values used in the embodiment.

It is to be noted that all or part of the structural elements of each of the memory control systems 100 and 100A are typically realized as an LSI (Large Scale Integration) that is an integrated circuit. These LSIs may be integrated into individual chips, or into a single chip so as to include part or all of the LSIs. In addition, the memory control systems 100 and 100A may be each configured as the integrated circuit.

Moreover, the present disclosure may be realized as a power control method having, as steps, the operations of the characteristic components included in the memory control systems 100 and 100A. Furthermore, the present disclosure may be realized as a program causing a computer to execute each of the steps included in such a power control method. In addition, the present disclosure may be realized as a computer-readable recording medium having such a program recorded thereon.

It should be considered that the embodiments disclosed herein are exemplary in all respects and not restrictive at all. It is intended that the scope of the present disclosure is indicated not by the above description of the embodiments but by claims, and that any change that has equivalent meaning as and fall within the claims are included.

### INDUSTRIAL APPLICABILITY

The present disclosure can be used as a memory control system that makes it possible to decrease as much as possible a time until an inaccessible memory is made operational, and to reduce power consumption.

1. A memory control system connected to a plurality of memories, the memory control system comprising:
a plurality of I/O circuits; and
a monitoring circuit that monitors usage states of the memories,
wherein each of the I/O circuits is connected t one of the memories,
when one of the memories is accessed, each of the I/O circuits that is connected thereto is used,
the I/O circuit consumes power to operate, and
the monitoring circuit determines, among the memories, a memory to which access is permitted, based on the usage states of the memories,
the memory control system further comprising
a power control circuit that performs, when a predetermined condition for the usage states of the memories is satisfied, and an unused memory is present among the memories, a power consumption reduction process for causing a target I/O circuit to consume less power than an other one of the I/O circuits, the target I/O circuit being an I/O circuit among the I/O circuits that is connected to the unused memory,
wherein the memories are set to have an n number of segments, n being an integer greater than or equal to 2,
each of the n number of the segments corresponds to all or part of a plurality of regions identified by the same address for the memories, and
the memories are accessed on a segment basis,
the memory control system further comprising
a memory management circuit that (a) makes, every time an instruction to perform an access process for accessing one of the n number of the segments is received, the segment to be accessed valid and (b) makes, every time a predetermined process for causing the access process at least once is completed, the segment to be accessed invalid,
wherein the monitoring circuit determines, among the memories, the memory to which access is permitted, based on the number of valid segments among the n number of the segments.

2. The memory control system according to claim 1,
wherein each of the I/O circuits includes a circuit used when the one of the memories connected to the I/O circuit is accessed, and
the power control circuit performs the power consumption reduction process for causing the target. I/O circuit to disable the circuit included in the I/O circuit that is the target I/O circuit.

3. The memory control system according to claim 1,
wherein the predetermined condition is a condition that a value dependent on the number of latest valid segments is less than or equal to a predetermined first threshold value.

4. The memory control system according to claim 3,
wherein the value dependent on the number of the latest valid segments is a ratio of the number of the latest valid segments to n.

5. The memory control system according to claim 4,
wherein the first threshold value is less than 0.5.

6. The memory control system according to claim 1,
wherein each of the memories is assigned a different priority level,
each of the n number of the segments is associated with segment information including memory usage information for identifying, among the memories, the memory to which access is permitted, and
the monitoring circuit determines, among the memories, the memory to which access is permitted, by updating, every time a process for accessing one of the n number of the segments is performed, the memory usage information included in the segment information so that access to, among the memories, a memory having a higher priority level as a memory corresponding to the segment to be accessed is permitted as the number of the valid segments is less.

7. The memory control system according to claim 1, further comprising
a plurality of functional circuits,
wherein each of the functional circuits performs a different process, and
the monitoring circuit determines, among the memories, the memory to which access is permitted, based on a maximum memory capacity used in the process performed by each functional circuit.

8. The memory control system according to claim 1,
wherein each of the I/O circuits is a circuit that uses a differential signal.

9. A power control method performed by a memory control system connected to a plurality of memories,
wherein the memory control system includes:
a plurality of I/O circuits; and
a monitoring circuit that monitors usage states of the memories,
each of the I/O circuits is connected to one of the memories,
when one of the memories is accessed, each of the I/O circuits that is connected thereto is used,
the I/O circuit consumes power to operate, and
the monitoring circuit determines, among the memories, a memory to which access is permitted, based on the usage states of the memories,
the power control method comprising
performing, when a predetermined condition for the usage states of the memories is satisfied, and an unused memory is present among the memories, a power consumption reduction process for causing a target I/O circuit to consume less power than an other one of the I/O circuits, the target I/O circuit being an I/O circuit among the I/O circuits that is connected to the unused memory,
wherein the memories are set to have an n number of segments, n being an integer greater than or equal to 2,
each of the n number of the segments corresponds to all or part of a plurality of regions identified by the same address for the memories, and
the memories are accessed on a segment basis,
the power control method further comprising
(a) making, every time an instruction to perform an access process for accessing one of the n number of the segments is received, the segment to be accessed valid and (b) making, every time a predetermined process for causing the access process at least once is completed, the segment to be accessed invalid, and
wherein the monitoring circuit determines, among the memories, the memory to which access is permitted, based on the number of valid segments among the n number of the segments.
